(19) United States
(12) Patent Application Publication
(10) Pub. No.: US 2010/0325375 A1
(43) Pub. Date: Dec. 23, 2010

(54) DATA-ACCESS CONTROL DEVICE AND DATA-ACCESS CONTROL METHOD

(75) Inventors: Akira UENO, Tokyo (JP); Naruyasu KOBAYASHI, Kawasaki-shi (JP)

Correspondence Address: VOLPE AND KOENIG, P.C., UNITED PLAZA, 30 SOUTH 17TH STREET, PHILADELPHIA, PA, 19103, US

(73) Assignee: OLYMPUS IMAGING CORP., Tokyo (JP)

(21) Appl. No.: 12/818,571

(22) Filed: Jun. 18, 2010

(30) Foreign Application Priority Data
Jun. 22, 2009 (JP) 2009-148063

(51) Int. Cl. G06F 12/00

(52) U.S. Cl. 711/158; 711/E12.001

(57) ABSTRACT

A memory control unit sequentially performs access requests to a plurality of banks A to D for a high-speed module 1 according to settings of the high-speed module, and subsequently performs an access request to a bank for a low-speed module after completion of a process of consecutive access requests for the high-speed module. In this case, an initial address that the high-speed module is to access is set to an address location for accessing a bank different from the low-speed module.

### CROSS-REFERENCE TO RELATED APPLICATIONS

This application is based upon and claims the benefit of priority from Japanese Patent Application No. 2009-148063, filed on Jun. 22, 2009, the entire contents of which are incorporated herein by reference.

### BACKGROUND OF THE INVENTION

1. Field of the Invention

The present invention relates to a data-access control device and a data-access control method applicable to an electronic equipment such as a digital camera having an SDRAM (synchronous dynamic RAM) as a memory.

2. Description of the Related Art

In recent years, an SDRAM is used not only in personal computers but also in various electronic equipments such as digital cameras. The SDRAM is accessed per data transfer unit called a burst length (e.g., a data length for eight words or four words), so that transfer efficiency is improved. Furthermore, the SDRAM is provided with an address space containing a plurality of banks and is equipped with a function called bank interleaving for sequentially accessing the plurality of banks in a switching manner, so that the transfer efficiency is further improved. This is because it is possible to load an address for a next bank in parallel while data is being transferred to a previously-accessed bank.

### SUMMARY OF THE INVENTION

A data-access control device according to an aspect of the present invention is for performing data access to a memory having an address space containing a plurality of banks from a plurality of modules configured to output a data access request. The data-access control device includes a high-speed module as one of the plurality of modules, the high-speed module outputting data for which priority of data access to the memory is relatively high; a low-speed module as one of the plurality of modules, the low-speed module outputting data for which priority of data access to the memory is relatively low; and a memory control unit that receives a data access request to the memory from each of the modules, transmits to a corresponding module a signal for allowing the data access request in order of priority of the data access request, and controls data access to the memory based on a memory access condition requested from a module whose data access request has been allowed. The high-speed module sequentially performs, to the memory control unit, consecutive data access requests as many as number of write requests to the plurality of banks to perform contiguous requests to different banks.

A data-access control method according to another aspect of the present invention is implemented by a data-access control device. The data-access control device includes a memory having an address space containing a plurality of banks; a high-speed module being a module that performs a data access request to the memory and that outputs data for which priority of data access to the memory is relatively high; a low-speed module being a module that performs a data access request to the memory and that outputs data for which priority of data access to the memory is relatively low; and a memory control unit that receives a data access request to the memory from each module, transmits to a corresponding module a signal for allowing the data access request in order of priority of the data access request, and controls data access to the memory based on a memory access condition requested from a module whose data access request has been allowed. The data-access control method includes sequentially performing, by the memory control unit, access requests to a plurality of banks for the high-speed module according to settings of the high-speed module, and subsequently performing an access request to a bank for the low-speed module after completion of a process of consecutive access requests for the high-speed module.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a general block diagram illustrating an example of a configuration including a data-access control device of a digital camera according to a first embodiment of the present invention;

FIG. 2A is a timing diagram illustrating an example of ideal access in order of priority;

FIG. 2B is a timing diagram illustrating an example of access when a measure according to the first embodiment is not taken;

FIG. 2C is a timing diagram illustrating an example of access when the measure according to the first embodiment is taken;

FIG. 3 is a timing diagram illustrating a transfer access unit for an SDRAM;

FIG. 4A is a timing diagram illustrating a detailed example of a case in which access to an identical bank occurs similarly to FIG. 2B;

FIG. 4B is a timing diagram illustrating a detailed example of a case in which the measure according to the first embodiment is taken;

FIG. 5 is a timing diagram illustrating how efficient a sequential processing method according to the first embodiment is on the same time base; and

FIG. 6 is a timing diagram illustrating an access processing method according to a second embodiment of the present invention.

### DETAILED DESCRIPTION OF THE PREFERRED EMBODIMENTS

Exemplary embodiments of the present invention will be explained below with reference to the accompanying drawings. The embodiments will be explained with an example of a data-access control device mounted on an imaging system such as a digital camera as an electronic equipment.

### First Embodiment

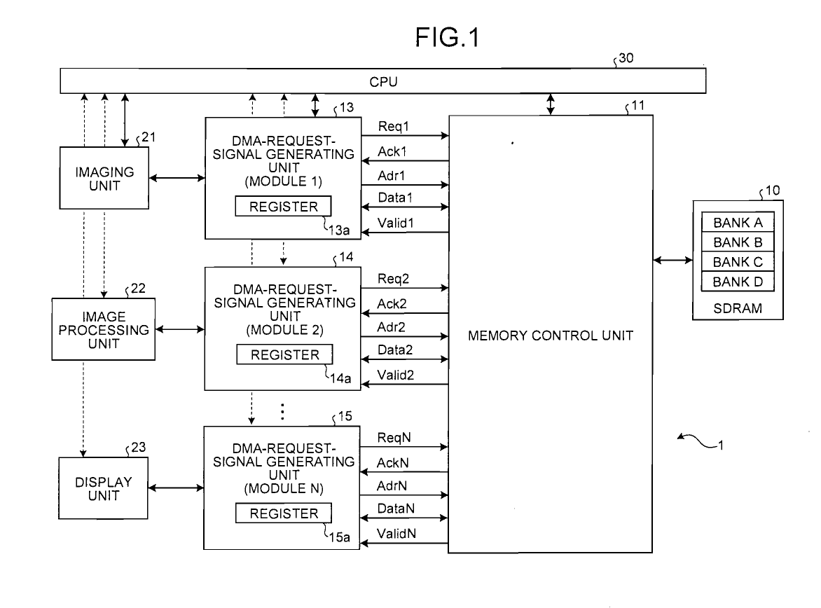

FIG. 1 is a general block diagram illustrating an example of a configuration including a data-access control device of a digital camera according to a first embodiment of the present invention. A data-access control device 1 according to the first embodiment includes an SDRAM 10, a memory control unit 11, and a plurality of DMA-request-signal generating units 13, 14, . . . , 15.

The SDRAM 10 has an address space containing a plurality of, for example, four banks A to D.

The DMA-request-signal generating unit 13 (module 1) sends a request for data transfer (Req1) and simultaneously outputs an access address (Adr1) to the memory control unit 11. When the data transfer is available, the memory control unit 11 allows the transfer (Ack1) and thereafter outputs a signal indicating that data is valid (Valid1). The DMA-request-signal generating unit 13 (module 1) transmits transfer data (Data1) at the time of writing and receives the transfer data (Data1) at the time of reading according to the Valid1 signal. In this case, data transferred from the DMA-request-signal generating unit 13 is a high-speed module having relatively high priority. The high priority is given when a predetermined amount of data is reliably transferred at a constant rate at any time, e.g., when image data generated based on an output from an imaging unit 21 having a solid imaging element such as a CCD is transferred.

On the other hand, the DMA-request-signal generating unit 14 (module 2) sends a request for data transfer (Req2) and simultaneously outputs an access address (Adr2) to the memory control unit 11. When the data transfer is available, the memory control unit 11 allows the transfer (Ack2) and thereafter outputs a signal indicating that data is valid (Valid2). The DMA-request-signal generating unit (module 2) transmits transfer data (Data2) at the time of writing and receives the transfer data (Data2) at the time of reading according to the Valid2 signal. In this case, data transferred from the DMA-request-signal generating unit 14 is image data output from an image processing unit 22 that performs various types of image processing, such as color correction processing and gamma processing, on image data stored in the SDRAM 10. Therefore, the DMA-request-signal generating unit 14 is a low-speed module having relatively low data-access priority, for which it is not necessary to transfer data at a constant rate at any time.

The DMA-request-signal generating unit 15 (module N) sends a request for data transfer (ReqN) and simultaneously outputs an access address (AdrN) to the memory control unit 11. When the data transfer is available, the memory control unit 11 allows the transfer (AckN) and thereafter outputs a signal indicating that data is valid (ValidN). The DMA-request-signal generating unit 15 (module N) transmits transfer data (DataN) at the time of writing and receives the transfer data (DataN) at the time of reading according to the Valid N signal. In this case, data transferred from the DMA-request-signal generating unit 15 is image data output to a display unit 23 formed of an LCD and the like included in the data-access control device 1. Therefore, the DMA-request-signal generating unit 15 (module N) is a high-speed module having relatively high priority, for which a predetermined amount of data needs to be reliably transferred at a constant rate at any time.

The memory control unit 11 substantially functions as a bus to which the SDRAM 10 and the DMA-request-signal generating units 13, 14, and the like are connected. The memory control unit 11 receives data transfer requests (Req1, Req2, . . . , ReqN) to the SDRAM 10 from the DMA-request-signal generating units 13, 14, . . . , 15 as requests Req, and transmits signals Ack to the respective DMA-request-signal generating unit 13, 14, . . . , 15 as enabling signals Ack1, Ack2, . . . , and AckN so as to allow the data transfer requests according to data access priority of the requests in response to the requests Req. Furthermore, the memory control unit 11 executes a bank interleaving function to control data access to each bank A to D of the SDRAM 10 based on memory access conditions such as transfer addresses requested from the allowed DMA-request-signal generating units 13, 14, . . . , and 15. The data access priority related to the DMA-request-signal generating units 13, 14, . . . , 15 is set by a CPU 30 on the memory control unit 11 side. Furthermore, the memory control unit 11 performs the above-mentioned control independent of the CPU 30 that controls the whole digital camera. Moreover, the memory control unit 11 arbitrates the data transfer requests from the plurality of DMA-request-signal generating units 13, 14, . . . , 15.

The DMA-request-signal generating unit 13 (module 1) having high data access priority is equipped with a function of sequentially performing transfer as many times as the number of banks in the SDRAM 10 (8-word burst×the number of banks×M, where M is an integer) in response to a single data access request. Therefore, the DMA-request-signal generating unit 13 (module 1) includes a register 13a for setting the number of accesses (the number of write requests to the plurality of banks) such that the number of accesses at one time is set by a register control unit of the CPU 30 and the like. A setting value of the number of accesses in the register 13a is set to the number of banks×M, i.e., an integral multiple of the number of banks. Furthermore, the register setting value is set based on a transfer rate and the amount of data. For example, when the SDRAM 10 is formed of four banks and “4” is set in the register 13a, the DMA-request-signal generating unit 13 (module 1) sequentially transfers data as much as single transfer=8-word burst×4. In other words, as soon as data in the amount of transfer data corresponding to the number of accesses set in the register 13a (8-word burst×register setting value) is accumulated, the DMA-request-signal generating unit 13 (module 1) issues and holds an access request to the memory control unit 11. Accordingly, the memory control unit 11 allows the DMA-request-signal generating unit 13 (module 1) to occupy a bus while the access request is being output from the DMA-request-signal generating unit 13 (module 1). Therefore, “sequential access” means that one of the DMA-request-signal generating units sequentially outputs data access requests at the time the memory control unit 11 does not select other module access.

Furthermore, when performing the sequential access, the DMA-request-signal generating unit 13 (module 1) performs the access with addresses by which the banks can be switched smoothly in the bank interleaving function. In other words, an initial address that the DMA-request-signal generating unit 13 (module 1) is to access is set to an address location for accessing a bank different from that of the DMA-request-signal generating unit 14 (module 2). For example, when the module 2 is to access the bank C or the bank B, the initial address that the module 1 is to access is set to a different bank such as the bank A or the bank D. Furthermore, the access address is changed per 8-word burst transfer during the sequential access. For example, the banks are switched from one to the bank A when lower 2 bits of the access address are “0”, to the bank B when the bits are “1”, to the bank C when the bits are “2”, and to the bank D when the bits are “0”.

In this manner, according to the first embodiment, the DMA-request-signal generating unit 13 (module 1) having high data access priority sends a single data access request to the memory control unit 11 to thereby sequentially perform consecutive data access requests as many as the number of write requests to the plurality of banks A to D to perform contiguous requests to different banks. Furthermore, the DMA-request-signal generating unit 13 (module 1) sends data, in which the initial address to be accessed is set to an address location for accessing a bank different from that of the DMA-request-signal generating unit 14 (module 2) having low priority, as an access request to the memory control unit 11.

Moreover, the DMA-request-signal generating unit 15 (module N) having high priority similarly to the DMA-request-signal generating unit 13 (module 1) also includes a register 15a for setting the number of accesses (the number of write requests to the plurality of banks), and is equipped with a sequential transfer function. The DMA-request-signal generating unit 14 (module 2) also includes a register 14a having the same configuration for setting the number of accesses. However, the number of accesses is not set in the first embodiment.

In this configuration, an example is described in which the DMA-request-signal generating unit 13 (module 1) having high priority and the DMA-request-signal generating unit 14 (module 2) having low priority are used as modules. Here, access to the SDRAM 10 is described below.

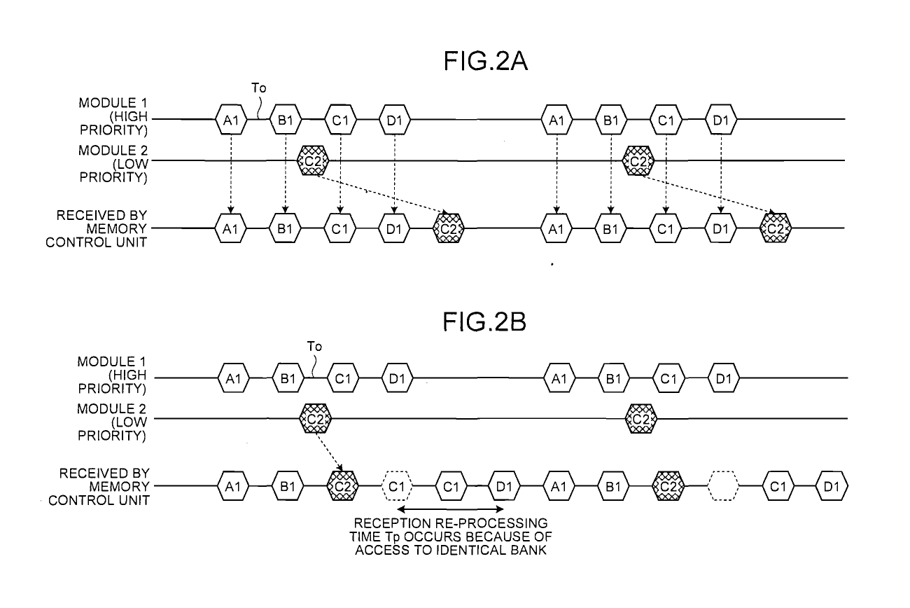

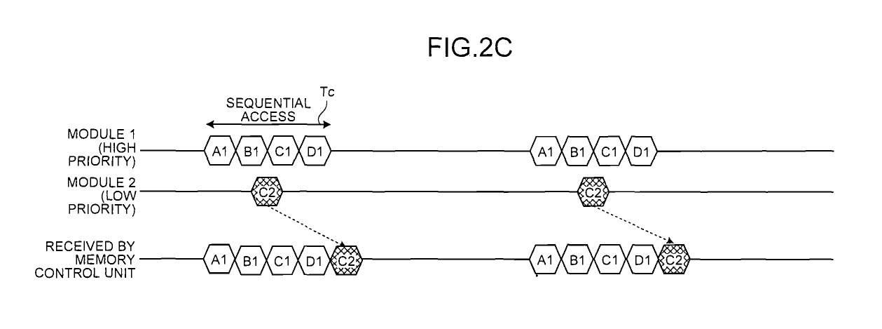

FIG. 2A is a timing diagram illustrating an example of ideal access in order of priority (output timing of a memory-control-unit reception Ack with respect to output timing of a transfer request Req from each module). In the figure, A to D denote the banks of the SDRAM 10. Access requests from the DMA-request-signal generating unit 13 (module 1) having high priority are indicated by subscript 1, and access requests from the DMA-request-signal generating unit 14 (module 2) having low priority are indicated by subscript 2 (the same is applied to the subsequent drawings).

In FIG. 2A, the module 1 having high priority outputs memory access requests to banks A1→B1→C1→D1 . . . , and the like at a constant rate. On the other hand, the module 2 having low priority outputs a memory access request to a bank C2 in a time between outputs of the memory access requests to the banks B1 and C1 from the module 1. In this case, the memory control unit 11 preferentially processes the accesses with high priority (A1→B1→C1→D1) at a time To, and performs a process (C2) for the module 2 after the process for the module 1 is completed.

FIG. 2B is a timing diagram illustrating an example of access when a measure according to the first embodiment is not taken. As illustrated in FIG. 2B, after processing the access request to the bank B1 from the module 1, the memory control unit 11 determines that there is no memory access request from the module 1 at the time To. Then, the memory control unit 11 processes the access request to the bank C2 from the module 2. Subsequently, the memory control unit 11 attempts to proceed to the process of the access request to the bank C1 from the module 1; however, there occurs access to an identical bank with respect to the bank C. Therefore, the access request to the bank C1 is received after completion of the process for a penalty processing time Tp that occurs with re-processing of the reception. Therefore, data transfer to the bank C1 from the module 1 having high priority is delayed.

In contrast, FIG. 2C is a timing diagram illustrating an example of access when the measure according to the first embodiment is taken. The memory accesses from the module 1 are sequentially performed for four banks, and a bus is not released and is occupied by the module 1 during a sequential access period Tc. Therefore, the memory control unit 11 sequentially receives the memory access requests for four banks from the module 1. Consequently, the memory access request to the bank C2 from the module 2 is performed after the access requests from the module 1 are finished. Thus, a preferential process for the module 1 having high priority can be performed effectively and a process for the module 2 having low priority can also be performed while preventing access to an identical bank, so that data transfer can efficiently be performed. In other words, even when the plurality of modules 1 and 2 performs access at the same time, consecutive accesses as many as the number of banks are treated as 1 set for the module 1 having high priority so that each bank A to D is consecutively and sequentially accessed. Therefore, access to an identical bank can hardly occur with the module 2 having low priority, so that the bank interleaving function can effectively be performed.

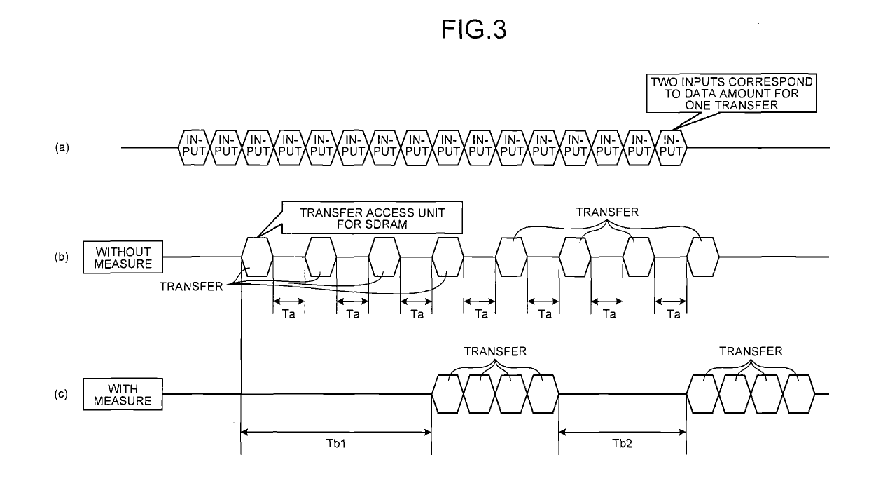

The examples of the timing diagrams described above are further explained from another perspective. FIG. 3 is a timing diagram illustrating a transfer access unit for an SDRAM. In this example, the access unit represents 1 burst. An input example illustrated in (a) of FIG. 3 indicates that two inputs correspond to a data amount for one transfer. In (b) of FIG. 3, an example of a transfer process performed by the module 1 when the measure according to the first embodiment as illustrated in FIG. 2B is not taken is illustrated, in which single transfer in transfer access units for the SDRAM frequently occurs. When the input is constant, a transfer request Req is frequently output at an interval of Ta. In this case, the interval Ta between each transfer is so small that access from the module 2 can hardly be input.

On the other hand, in (c) of FIG. 3, an example of a transfer process performed by the module 1 when the measure according to the first embodiment as illustrated in FIG. 2C is taken is illustrated. In other words, a case is illustrated in which four sequential transfers periodically occur in transfer access units for the SDRAM. In this case, sequential transfer intervals Tb1 and Tb2 are large enough, so that access from the module 2 having low priority can easily be input. In other words, the access from the module 2 having low priority can easily be processed in the sequential transfer intervals.

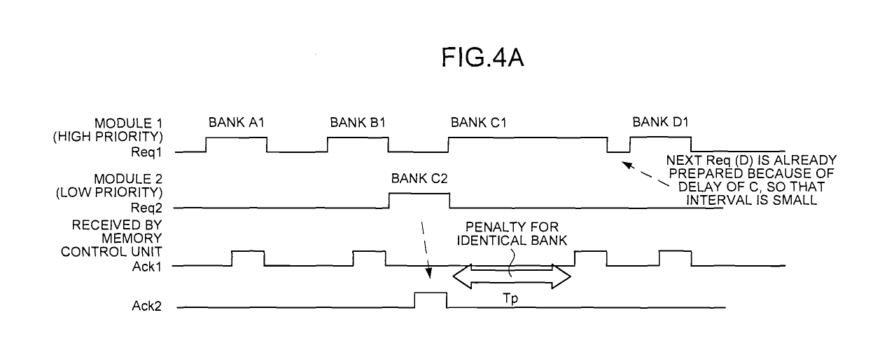

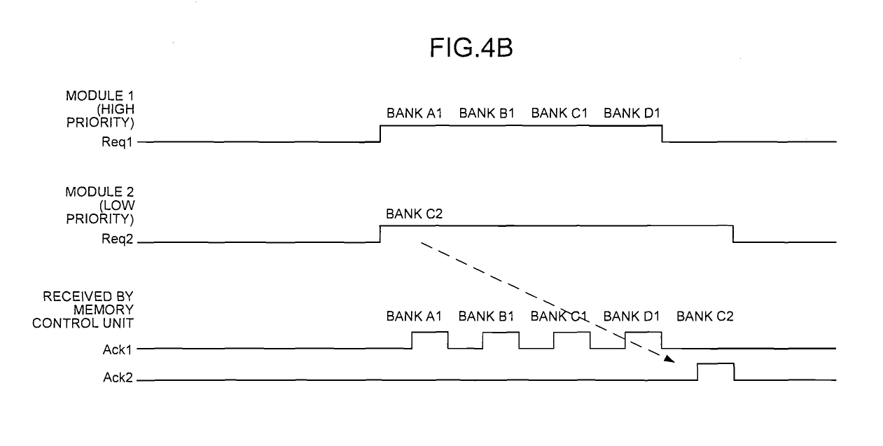

FIGS. 4A and 4B are timing diagrams illustrating detailed examples with actual waveforms of request signals Req and response signals Ack, in accordance with FIGS. 2B and 2C, respectively. In each case, it is assumed that 1 transfer=1 burst (e.g., eight words). In FIG. 4A, similarly to the example illustrated in FIG. 2B, access to an identical bank occurs between the data transfer request to the bank C1 from the module 1 and the data transfer request to the bank C2 from the module 2. Therefore, the penalty processing time Tp occurs.

On the other hand, FIG. 4B corresponds to the example of the sequential access method illustrated in FIG. 2C. The access requests from the module 1 are sequentially processed for the banks A1 to D1 by occupying a bus. Therefore, even at the time of the data transfer request to the bank C2 from the module 2, the data transfer request to the bank C2 is performed after the process for the module 1 is completed. In this manner, in FIG. 4B, the access requests from the module 1 having high access priority can reliably be processed in sequence regardless of the time of the data access request from the module 2.

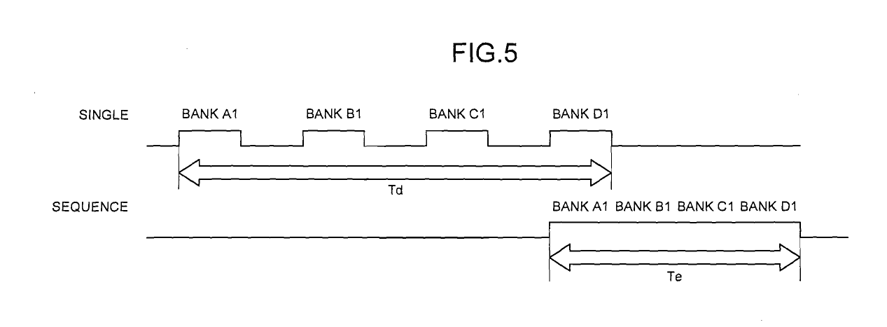

FIG. 5 is a timing diagram illustrating how efficient a sequential processing method according to the first embodiment is on the same time base. FIG. 5 illustrates lengths of processing time of a single method according to the conventional technology and a sequential method according to the first embodiment by comparison on the same time base. With the sequential method, a processing time The can sufficiently be shortened compared to a processing time Td in the single method, so that good data transfer efficiency can be achieved.

In this manner, according to the first embodiment, in a system configuration including the plurality of modules 1 and 2 each having different data access priority, data transfer for the module 1 having high priority can reliably be performed at a constant rate. Therefore, it is possible to prevent failure of the system. Furthermore, because the number of accesses for performing the sequential access at one time (the number of write or read requests) is set in the register 13a of the module 1, reconfiguration is not necessary even when the type of the SDRAM 10 is changed. Therefore, versatility can be improved.

### Second Embodiment

Next, a second embodiment of the present invention is explained. The second embodiment is described with an example to be suitably applied to a case in which the number of modules connected to the memory control unit 11 is increased from that of the first embodiment described above. Although not illustrated in FIG. 1, it is assumed in the second embodiment that a module (DMA-request-signal generating unit) 3 is included in addition to the modules 1, 2, and N. Data transferred from the module 3 is used for storing image data that has been stored in the SDRAM 10 in a card recording medium (media) for example. Therefore, the module 3 is a low-speed module having relatively low data access priority, for which it is not necessary to transfer data at a constant rate at any time.

Under the condition where a plurality of modules having relatively high data access priority is included, in the second embodiment, the four modules 1, 2, 3, N that access the SDRAM 10 are divided into two groups 1 and 2. In this case, the group 1 is provided so that the module 1 and the module N having relatively high data access priority, for which transfer needs to be performed reliably at a constant rate at any time as described above, are handled as one group. Furthermore, the group 2 is provided so that the module 2 and the module 3 having relatively low data access priority, for which transfer at a constant rate for example is not necessary, are handled as one group. Then, priority is set in units of groups for the groups 1 and 2 such that the priority of the group 1 becomes higher than the priority of the group 2. Furthermore, the highest priority is set to the group 1 so that the priority becomes higher than the data access priority for each module and the priority for selecting banks to be switched in the interleaving function. Settings for grouping the modules 1, 2, 3, N as described above are made by the CPU 30 on the memory control unit 11 side.

In the group 1, the data access priority is different between the modules 1 and N. For example, the data access priority of the module 1 is set higher than that of the module N. Similarly, in the group 2, the data access priority is different between the modules 2 and 3. For example, the data access priority of the module 2 is set higher than that of the module 3.

The memory control unit 11 complies with the priority of the groups due to the grouping as described above, and masks a data access request from all the modules 2 and 3 in the group 2 when receiving a data access request from either the module 1 or the module N in the group 1 having high priority. In this manner, the memory control unit 11 controls not to refer to the data access request from the group 2. Then, the memory control unit 11 processes the data access request from either the module 1 or the module N in the group 1. At this time, when data access requests are simultaneously output from the modules 1 and N in the same group 1, the memory control unit 11 sequentially processes the data access requests according to the priority of the modules 1 and N.

The memory control unit 11 releases the masks for the group 2 and controls to resume reception of the data access request from the group 2 having low priority only when a data access request is not output from the group 1 having high priority. Then, the memory control unit 11 processes the data access request from either the module 2 or the module 3 in the group 2. In this case, when data access requests are simultaneously output from the modules 2 and 3 in the same group 2, the memory control unit 11 sequentially processes the data access requests according to the priority of the modules 2 and 3.

In other words, the memory control unit 11 allows the group 1 to occupy the bus until all data access requests from the modules 1 and N grouped into the group 1 having high priority are finished. Accordingly, the memory control unit 11 controls to mask data access requests from the other modules 2 and 3 outside of the group 1.

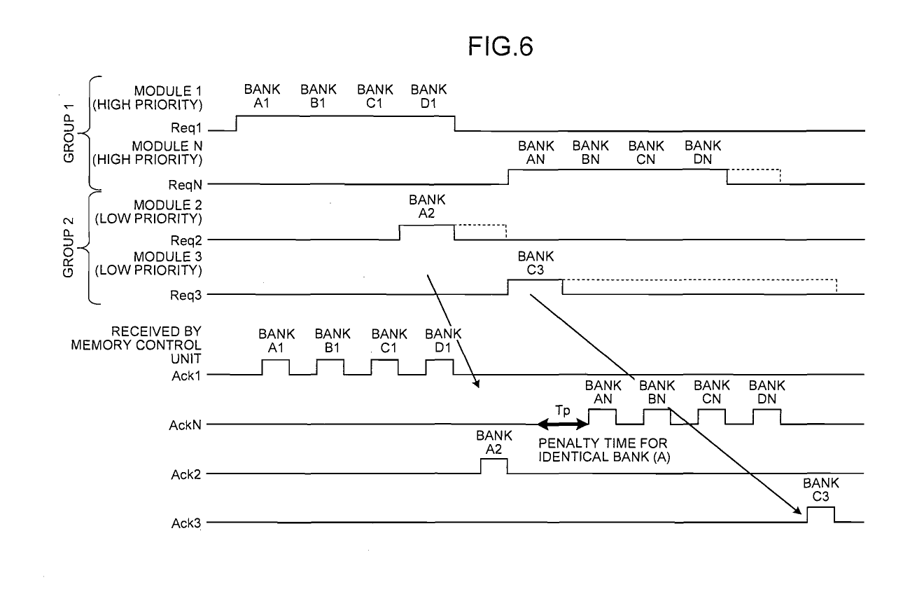

In this configuration, a detailed example of access processing is described with reference to FIG. 6. FIG. 6 is a timing diagram illustrating an access processing method according to the second embodiment of the present invention with use of request signals Req and response signals Ack. Access requests from the module 1 belonging to the group 1 are processed in sequence for the banks A1 to D1 by occupying the bus similarly to the case of the first embodiment. Therefore, regardless of the time of a data transfer request to the bank A2 from the module 2 belonging to the group 2 having low priority, the data transfer request to the bank A2 is performed after the process for the module 1 (the group 1) is completed. In other words, the memory control unit 11 masks the access request from the group 2 so as not to refer to this access request while the access request from the module 1 belonging to the group 1 is being output. Then, after the access from the module 1 is finished, the memory control unit 11 releases the mask, resumes the access request to the bank A output from the module 2, and receives the access request by the response signal Ack2. Then, the memory control unit 11 performs the process according to the access request from the module 2.

In the subsequent time in FIG. 6, a situation is illustrated in which consecutive access requests to the banks A to D from the module N belonging to the group 1 having high priority and an access request to the bank C from the module 3 belonging to the group 2 having low priority are output simultaneously.

In this case, if the modules are not divided into groups, because the access to the bank A from the module 2 is issued just before the requests, the memory control unit 11 executes the interleaving function for which priority is set higher than the priority of each module and selects the access request from the module 3 having low priority in order to prevent access to an identical bank. If such a situation frequently occurs, data transfer for the module N having high priority may be delayed, so that the system may be significantly affected. For example, when the module N is used for image display on the display unit 23, there is a risk in that an image may not be displayed correctly on a liquid crystal screen because of the delay in the data transfer for the module N.

In contrast, according to the second embodiment, the plurality of modules 1 and N having relatively high priority are handled as the group 1 having the highest priority. Therefore, even when the penalty time Tp occurs because an identical bank is specified due to a plurality of access requests output at the same time as described above, the memory control unit 11 preferentially receives the access request from the module N belonging to the group 1 having high priority. Therefore, the access requests for the banks AN to DN are sequentially processed by occupying the bus. Consequently, a data transfer request to the bank C3 from the module 3 belonging to the group 2 having low priority is performed after the process for the module N (group 1) is completed. In other words, the memory control unit 11 masks access requests from the module 2 in the group 2 so as not to refer to the access request while an access request from the module N belonging to the group 1 is being output. Then, after the access from the module 1 is finished, the memory control unit 11 releases the mask, resumes the access request to the bank C3 output from the module 2, and receives the access request by the response signal Ack3. Then, the memory control unit 11 performs the process according to the access request from the module 3.

It is possible to add the same register (not illustrated) as those of the modules 1, 2, 3, N to the memory control unit 11 so that mask processing can be performed for each group according to settings made in the register in the memory control unit 11 by the CPU 30.

In this manner, according to the second embodiment, in addition to the advantages of the first embodiment, a plurality of modules having relatively high priority is handled as one group having the highest priority. Therefore, access control is performed such that the highest priority is given to the groups over switching performed by the bank interleaving function for preventing access to an identical bank. As a result, it is possible to prevent interference with the access request from the modules having higher priority than the bank interleaving function. Thus, it is possible to prevent failure of the system.

Although it is explained in the second embodiment that two modules belong to the group 1, three or more modules may belong to the group 1. Furthermore, modules having relatively low priority may be grouped as the group 2, may be remained as individual modules, or may be provided singularly.

The descriptions in the first and the second embodiments can be applied to both data read and data write between the modules and the SDRAM, and not limited to the data write to the SDRAM 10. Furthermore, the present invention is not limited to the digital camera, and can be applied to various types of electronic equipments such as mobile phones and video cameras having an SDRAM and a plurality of modules.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data-access control device for performing data access to a memory having an address space containing a plurality of banks from a plurality of modules configured to output a data access request, the data-access control device comprising:
a high-speed module as one of the plurality of modules, the high-speed module outputting data for which priority of data access to the memory is relatively high;
a low-speed module as one of the plurality of modules, the low-speed module outputting data for which priority of data access to the memory is relatively low; and
a memory control unit that receives a data access request to the memory from each of the modules, transmits to a corresponding module a signal for allowing the data access request in order of priority of the data access request, and controls data access to the memory based on a memory access condition requested from a module whose data access request has been allowed, wherein
the high-speed module sequentially performs, to the memory control unit, consecutive data access requests as many as number of write requests to the plurality of banks to perform contiguous requests to different banks.

2. The data-access control device according to claim 1, wherein
the high-speed module sets the number of consecutive write requests to an integral multiple of number of banks in the memory.

3. The data-access control device according to claim 1, wherein
the high-speed module sets number of consecutive write requests based on a transfer rate and data amount.

4. The data-access control device according to claim 1, wherein
a plurality of modules, including the high-speed module, having relatively high data access priority is handled as one group, and data access priority of the group is set higher than other modules outside of the group.

5. The data-access control device according to claim 4, wherein
the memory control unit allows the group to occupy a bus until all data access requests from the plurality of modules in the group are finished, and performs mask processing to mask a data access request from other modules outside of the group.

6. The data-access control device according to claim 5, wherein
the mask processing is performed for each group according to setting by the memory control unit.

7. A data-access control method implemented by a data-access control device including
a memory having an address space containing a plurality of banks;
a high-speed module being a module that performs a data access request to the memory and that outputs data for which priority of data access to the memory is relatively high;
a low-speed module being a module that performs a data access request to the memory and that outputs data for which priority of data access to the memory is relatively low; and
a memory control unit that receives a data access request to the memory from each module, transmits to a corresponding module a signal for allowing the data access request in order of priority of the data access request, and controls data access to the memory based on a memory access condition requested from a module whose data access request has been allowed, the data-access control method comprising:
sequentially performing, by the memory control unit, access requests to a plurality of banks for the high-speed module according to settings of the high-speed module, and subsequently performing an access request to a bank for the low-speed module after completion of a process of consecutive access requests for the high-speed module.
